(19) United States
(12) Patent Application Publication
(10) Pub. No.: US 2018/0101960 A1
(43) Pub. Date: Apr. 12, 2018

(54) COMBINATION VIDEO SURVEILLANCE SYSTEM AND PHYSICAL DETERRENT DEVICE

(71) Applicant: Avigilon Corporation, Vancouver (CA)

(72) Inventors: Waris Boonyasiriwat, Vancouver (CA); Levente Buzas, Victoria (CA); Joel Geddert, Vancouver (CA); Alexander Fernandes, Vancouver (CA); Eric Little, Vancouver (CA); Joseph Liu, Vancouver (CA); Christopher James Cullington Okrainetz, Vancouver (CA); Mahesh Saptharishi, Sudbury, MA (US); Yang Wang, Coquitlam (CA)

(73) Assignee: Avigilon Corporation, Vancouver (CA)

(21) Appl. No.: 15/288,908

(22) Filed: Oct. 7, 2016

(51) Int. Cl. G06T 7/20; G06T 7/00; G06K 9/00; H04N 7/18

(52) U.S. Cl. CPC G06T 7/2093; G06T 7/004; G06T 7/0081; G06K 9/00771; G06T 2207/30232; G06T 2207/10016; G06T 2207/10024; G06T 2207/20144; H04N 7/181

(57) ABSTRACT

A combination video surveillance system and physical deterrent device is disclosed. At least one camera module of the video surveillance system defines a first field of view and is operable to generate image data corresponding to the first field of view. A video analytics module is configured to detect a foreground visual object falling within the first field of view, classify the visual object, and determine an appearance of the visual object. A positioning module is configured to determine a physical location of the visual object. A deterrence device controller is configured to receive the determined physical location of the visual object, to control a deterrence device to be aimed at the physical location of the visual object, and to control the deterrence device to selectively emit the physical effect.

### FIELD

The present subject-matter relates to a video surveillance system and method, and more particularly to a video surveillance system that operates in combination with a physical deterrent device.

### BACKGROUND

A camera may be used to acquire information about a place or an object. The information is visual image data generated by the camera corresponding to the scene falling with the field of view of the camera. A variety of different types of cameras employed for security-related purposes exist in the market place. Just a few examples of cameras employed for security-related purposes include Internet Protocol (IP) cameras, traditional analog cameras (also commonly known as Closed Circuit Television cameras), high definition analog cameras, edge recording cameras, analytics-enabled cameras, etc.

Video surveillance systems, which are often built and assembled using many different components including cameras, have very widely recognized purposes including, for example, increasing detection and deterrence of illicit activities on and around a property owned or occupied by a business or person. In this regard, a typical video surveillance system uses one or more cameras to acquire information about an area being monitored, which serves to support the purpose(s) for which the business or person obtained the video surveillance system. The one or more cameras are placed in predetermined locations to ensure appropriate coverage of the area being monitored.

### SUMMARY

According to one example embodiment, there is provided a video surveillance system. The video surveillance system includes at least one camera module that defines a first field of view. The at least one camera module is operable to generate image data corresponding to the first field of view. A video analytics module is configured to detect a foreground visual object falling within the first field of view, classify the visual object, and determine an appearance of the visual object. A positioning module is configured to determine a physical location of the visual object. A deterrence device controller is communicatively coupled to the positioning module, and the deterrence device controller is configured to receive the physical location of the visual object from the positioning module. A deterrence device operable under control of the deterrence device controller is capable of being aimed at the physical location of the visual object, and the deterrence device controller is further configured to control the deterrence device to selectively emit the physical effect.

According to another example embodiment, there is provided a method that includes generating image data corresponding to a first field of view of a camera module. The method also includes detecting a foreground visual object falling within the first field of view and, after the detecting, classifying the visual object and determining an appearance thereof. The method also includes determining a physical location of the visual object and receiving, at a deterrence device controller, the determined physical location of the visual object. The method also includes aiming a deterrence device at the physical location of the visual object. The method also includes selectively emitting the physical effect from the deterrence device. Both the aiming and the selectively emitting may be controlled by the deterrence device controller.

### BRIEF DESCRIPTION OF THE DRAWINGS

The detailed description refers to the following figures, in which:

FIG. 1 illustrates a block diagram of a video surveillance system according to example embodiments;

FIG. 2 illustrates a flow chart of a method, according to an example embodiment, for determining pan and tilt angles to aim a deterrent device operable within the video surveillance system of FIG. 1; and

FIG. 3 illustrates a flowchart of a method, according to an example embodiment, for deploying the deterrent device operable within the video surveillance of FIG. 1.

It will be appreciated that for simplicity and clarity of illustration, elements shown in the figures have not necessarily been drawn to scale. For example, the dimensions of some of the elements may be exaggerated relative to other elements for clarity. Furthermore, where considered appropriate, similar or the same reference numerals may be used in the figures to indicate corresponding or analogous elements.

### DETAILED DESCRIPTION OF VARIOUS EMBODIMENTS

Numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered in any way claim scope limiting, but rather as merely describing the implementation of the various example embodiments herein described.

“Image data” herein refers to data produced by a camera device and that represents images captured by the camera device. The image data may include a plurality of sequential image frames, which together form a video captured by the camera device. Each image frame may be represented by a matrix of pixels, each pixel having a pixel image value. For example, the pixel image value may be a numerical value on grayscale (for example, 0 to 255) or a plurality of numerical values for colored images. Examples of color spaces used to represent pixel image values in image data include RGB, YUV, CYKM, YCBCR 4:2:2, and YCBCR 4:2:0 images. It will be understood that “image data” as used herein can refer to “raw” image data produced by the camera device and/or to image data that has undergone some form of processing. It will be further understood that “image data” may refer to image data representing captured visible light in some examples and may refer to image data representing captured depth information and/or thermal information.

“Foreground visual object” herein refers to a visual representation of a real-life object (for example, person, animal, vehicle) found in the image frames captured by the video capture device. The foreground visual object is one that is of interest for various purposes, one of which is video surveillance, and the presence of a foreground visual object in a scene may represent an event such as, for example, a human presence or vehicle presence. A foreground visual object may be a moving object or a previously moving object. The foreground visual object is distinguished from a background object, which is an object that is found in the background of a scene and which is not of interest. For example, at least one image frame of the video may be segmented into foreground areas and background areas. One or more foreground visual objects in the scene represented by the image frame are detected based on segmentation. For example, any discrete contiguous foreground area or “blob” may be identified as a foreground visual object in the scene. For example, only contiguous foreground areas greater than a certain size (ex: number of pixels) are identified as a foreground visual object in the scene.

“Processing image data” (or variants thereof) herein refers to one or more computer-implemented functions performed on image data. For example, processing image data may include, but is not limited to, image processing operations, analyzing, managing, compressing, encoding, storing, transmitting and/or playing back the video data. Analyzing the image data may include segmenting areas of image frames and detecting objects, tracking and/or classifying objects located within the captured scene represented by the image data. The processing of the image data may cause modified image data to be produced, such as compressed (for example, lowered quality) and/or re-encoded image data. The processing of the image data may also cause additional information regarding the image data or objects captured within the images to be outputted. For example, such additional information is commonly understood as metadata. The metadata may also be used for further processing of the image data, such as drawing bounding boxes around detected objects in the image frames.

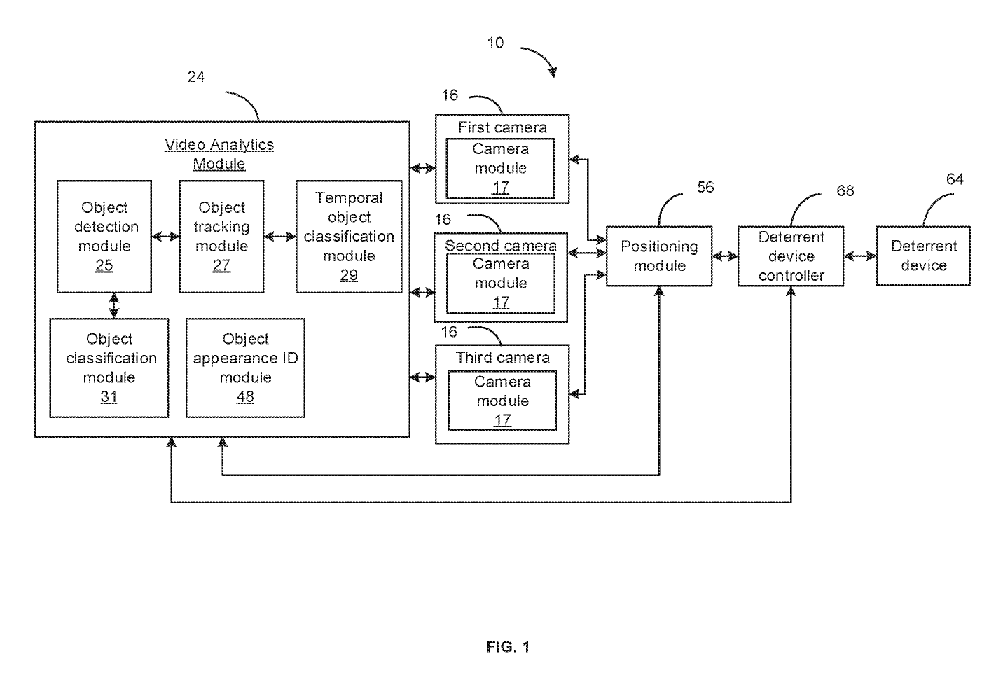

Reference will now be made to FIG. 1. FIG. 1 illustrates a block diagram of a video surveillance system 10 according to example embodiments. The video surveillance system 10 includes one or more cameras 16 (three cameras 16 are shown in FIG. 1 for convenience of illustration; however any suitable number of cameras is contemplated).

The one or more cameras 16 each includes one or more processors, one or more memory devices coupled to the processors and one or more network interfaces. The one or more memory devices can include local memory (for example, a random access memory, flash or other non-volatile memory, and a cache memory) employed during execution of program instructions. The processor executes computer program instructions (for example, an operating system and/or application programs), which can be stored in the one or more memory devices. Also, it will be understood that, although in some example embodiments the cameras 16 will be digital cameras, in alternative example embodiments the cameras 16 can be convention analog security cameras (or even non-conventional HD analog cameras). In some example embodiments employing analog cameras, cameras cooperate with an external video analytics module, where the video analytics module is capable of receiving analog video and is aware of the positioning and field of view of each camera coupled to it.

In various embodiments, a processor in one of the cameras 16 may be implemented by any processing circuitry having one or more circuit units, including a digital signal processor (DSP), graphics processing unit (GPU), embedded processor, etc., and any combination thereof operating independently or in parallel, including possibly operating redundantly. Such processing circuitry may be implemented by one or more integrated circuits (IC), including being implemented by a monolithic integrated circuit (MIC), an Application Specific Integrated Circuit (ASIC), a Field Programmable Gate Array (FPGA), etc. or any combination thereof. Additionally or alternatively, such processing circuitry may be implemented as a programmable logic controller (PLC), for example.

In various example embodiments, a memory device is coupled to the processor circuit and is operable to store date and computer program instructions. Typically, the memory device is all or part of a digital electronic integrated circuit or formed from a plurality of digital electronic integrated circuits. The memory device may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device may be operable to provide storage in the form of volatile memory, non-volatile memory, dynamic memory, etc. or any combination thereof.

In various example embodiments, a plurality of the components of the camera may be implemented together within a system on a chip (SoC). For example, the processor, the memory device and the network interface may be implemented within a SoC. Furthermore, when implemented in this way, both a general purpose processor and DSP may be implemented together within the SoC.

Each of the camera devices 16 includes a camera module 17 that is operable to capture a plurality of images and generate image data representing the plurality of captured images.

The camera module 17 generally refers to the combination of hardware and software sub-modules of the camera 16 that operate together to capture the plurality of images of a scene. Such sub-modules may include an optical unit (for example, camera lens) and an image sensor. In the case of a digital camera module, the image sensor may be, for example, a CMOS, NMOS, or CCD type image sensor. It will be understood though that, for at least some example embodiments, it is not necessary that the camera module be a digital camera module.

The lens and sensor combination defines a field of view. When positioned at a given location and according to a given orientation, the camera module 17 is operable to capture the real-life scene falling within the field of view of the camera and to generate image data of the captured scene.

The camera module 17 may perform some processing of captured raw image data, such as compressing or encoding the raw primary image data.

According to various example embodiments, the camera module 17 in at least some of the cameras 16 is a pan-tilt-zoom module (“PTZ”) that is operable to be displaced and/or rotated in a pan direction and in a tilt direction, and is further operable for performing optical zoom. The panning, tilting and/or zooming causes a change in the field of view of the camera module 17. For example, the camera module 17 may include one or more motors to cause the optical unit of the camera module 17 to be panned, tilted, or zoomed, as will be understood by those skilled in the art.

According to the various example embodiments where the camera module 17 is a pan-tilt-zoom module, the camera device further includes a PTZ control for controlling the panning, tilting, and zooming. The PTZ control may receive PTZ commands that are i) issued according to a human operator interacting with an input device; or ii) issued by a computer-implemented module (for example, an object tracking module) automatically. The PTZ control is further operable for generating control signals for controlling the one or more motors based on the received PTZ commands.

The video surveillance system 10 further includes a video analytics module 24. The video analytics module 24 receives image data from the camera module 17 of the camera 16 and analyzes the image data to determine properties or characteristics of the captured image or video and/or of objects found in scene represented by the image or video. Based on the determinations made, the video analytics module 24 may further output metadata providing information about the determinations. Examples of determinations made by the video analytics module 24 may include one or more of foreground/background segmentation, object detection, object tracking, object classification, virtual tripwire, anomaly detection, color recognition, facial detection, facial recognition, license plate recognition, identifying objects “left behind”, monitoring objects (for example, to protect from stealing), appearance searching, business intelligence, and deciding a position change action. However, it will be understood that other video analytics functions known in the art may also be implemented by the video analytics module 24.

The video analytics module 24 may be implemented within the one or more cameras 16. Alternatively, the video analytics module 24 may be implemented within a processing appliance or server that is external to the cameras 16. In some example embodiments, some of the cameras 16 may have an integrated video analytics module 24 while other cameras are coupled to an external processing appliance or server that implements the video analytics module 24. In still other example embodiments, part of the functionality of the video analytics module 24 may be implemented by all or a portion of the cameras 16, and the remaining part may be implemented by the processing appliance or server.

According to various example embodiments, the video analytics module 24 includes a number of modules for performing various tasks. For example, the video analytics module 24 includes an object detection module 25 for detecting objects appearing in the field of view of the one or more cameras 16. The object detection module 25 may employ any known object detection method such as motion detection and blob detection, for example. The object detection module 25 may have an implementation at least substantially similar to what is described in commonly owned U.S. Pat. No. 7,627,171 entitled “Methods and Systems for Detecting Objects of Interest in Spatio-Temporal Signals”.

The video analytics module 24 may also include an object tracking module 27 coupled to the object detection module 25. The object tracking module 27 is operable to temporally associate instances of an object detected by the object detection module 25. The object tracking module 27 may have an implementation at least substantially similar to what is described in commonly owned U.S. Pat. No. 8,224,029 entitled “Object Matching for Tracking, Indexing, and Search”. The object tracking module 27 generates metadata corresponding to visual objects it tracks. The metadata may correspond to signatures of the visual object representing the appearance of the object or other features. In some example embodiments, the object tracking module 27 can communicate information, via a positioning module, to a deterrent device controller on a continuous basis to allow a controlled deterrent device to follow a tracked object.

The video analytics module 24 may also include a temporal object classification module 29 coupled to the object tracking module 27. The temporal object classification module 29 is operable to classify an object according to its type (for example, human, vehicle, animal) by considering the appearance of the object over time. In other words, the object tracking module 27 tracks an object for multiple frames, and the temporal object classification module 29 determines the type of the object based upon its appearance in the multiple frames. For example, gait analysis of the way a person walks can be useful to classify a person, or analysis of legs of a person can be useful to classify a cyclist. The temporal object classification module 29 may combine information regarding the trajectory of an object (for example, whether the trajectory is smooth or chaotic, whether the object is moving or motionless) and the confidence of classifications made by an object classification module 31 (described in detail below) averaged over multiple frames. For example, classification confidence values determined by the object classification module 31 may be adjusted based on the smoothness of trajectory of the object. The temporal object classification module 29 may assign an object to an unknown class until the visual object is classified by the object classification module 31 a sufficient number of times and a predetermined number of statistics has been gathered. In classifying an object, the temporal object classification module 29 may also take into account how long the object has been in the field of view. The temporal object classification module 29 may make a final determination about the class of an object based on the information described above. The temporal object classification module 29 may also use a hysteresis approach for changing the class of an object. More specifically, a threshold may be set for transitioning the classification of an object from unknown to a definite class, and that threshold may be larger than a threshold for the opposite transition (for example, from a human to unknown). The temporal object classification module 29 may generate metadata related to the class of an object. The temporal object classification module 29 may aggregate the classifications made by the object classification module 31.

The video analytics module 24 also includes an object classification module 31, preferably coupled to the object detection module 25 directly or indirectly. In contrast to the temporal object classification module 29, the object classification module 31 may determine the type of a visual object based upon a single instance (for example, single image) of the object. The input to the object classification module 31 is preferably a sub-region of an image frame in which the visual object of interest is located rather than the entire image frame. A benefit of inputting a sub-region of the image frame to the object classification module 31 is that the whole scene need not be analyzed for classification, thereby requiring less processing power. Other preliminary modules, such as a heuristics-based modules to catch obvious classifications, can also be included to further simplify the complexity of the object classification module 31.

In an alternative arrangement, the object classification module 31 is placed after the object detection module 25 and before the object tracking module 27 so that object classification occurs before object tracking. In another alternative arrangement, the object detection, tracking, temporal classification, and classification modules are interrelated as described above.

The video analytics module further includes an object appearance identification module 48 that is configured to determine a visual appearance of the object. For example, the object appearance module 48 may determine characteristics of visual appearance of the object that distinguish the object from any other objects captured by the one or more cameras 16. For example, the characteristics of visual appearance may uniquely identify the object. Characteristics of visual appearance may include, for example, biometric features, clothing, accessories worn, etc.

The video surveillance system 10 further includes a positioning module 56 that is communicatively coupled to the analytics module 24. For example, the positioning module 56 acts in response to signals from video analytics module 24. The positioning module 56 is configured to determine the location of the object detected by the object detection module 25 of the video analytics module 24. Also, in respect of the illustrated video surveillance system 10, the positioning module 56 is shown as communicatively coupled to each of the cameras 16. In alternative example embodiments, there may be a number of positioning modules each communicatively coupled to a respective subset of cameras, where the size of each subset of cameras may be one camera, two cameras, three cameras, four cameras or any suitable number of cameras.

In accordance with one example embodiment, the location of the object may be detected based on visual analysis of image data from a single camera 16. For instance, visual analysis of the image data may reveal that the object is approaching and is sufficiently close to a known position location that a deterrent device is pre-calibrated to be able to target, and thus the physical effect of the deterrent device once timely emitted is consequently targeted at the object. Alternatively, the egress port of the deterrent device may be positioned very close to the single camera, in order to minimize the location difference error, and then pixel coordinates of the object, as determined by analytics, may be used to calculate yaw and pitch angles based on the known field of view of the camera, which will in turn be the yaw and pitch angles of the deterrent device because the single camera and the deterrent device are positioned sufficiently close together such that the location difference error is not too large. Since using a single camera as described above will not yield depth information, the above described embodiment is more likely to be suitable where depth information is not needed.

In accordance with another example embodiment, the location of the object of interest may be detected based on image data from one or more cameras 16 capturing light in the visible range and additional data from a camera capturing light outside of the visible range. For example, the additional data may be depth data. This depth data may be captured by, for instance, one or more of a depth camera, a time-of-flight camera, a stereoscopic camera or a LIDAR-enabled camera.

In accordance with another example embodiment, the location of the object may be detected based on the image data from one or more cameras combined with digitizable non-image sensory input (i.e. non-image data). The non-image data may refer to any suitable non-visual data, such as, for instance, audio or pressure. In some examples, infrared presence detectors, thermal (infrared) camera and/or metal detectors may be used. In those instances where the targeting of a noise nuisance is called for, capturing and making use of audio input may be particularly useful.

In accordance with another example embodiment, the positioning module 56 relies upon data sourced to the video analytics module 24 from at least two analytics-enabled cameras (one or more of which may be, but not necessarily, of a different type than any of the cameras 16). For this example embodiment, the two analytics-enabled cameras may function as spotter cameras, and they may be pointed at a same scene but from different angles (for instance, they could be set at an angle difference of 90 degrees relative to each other).

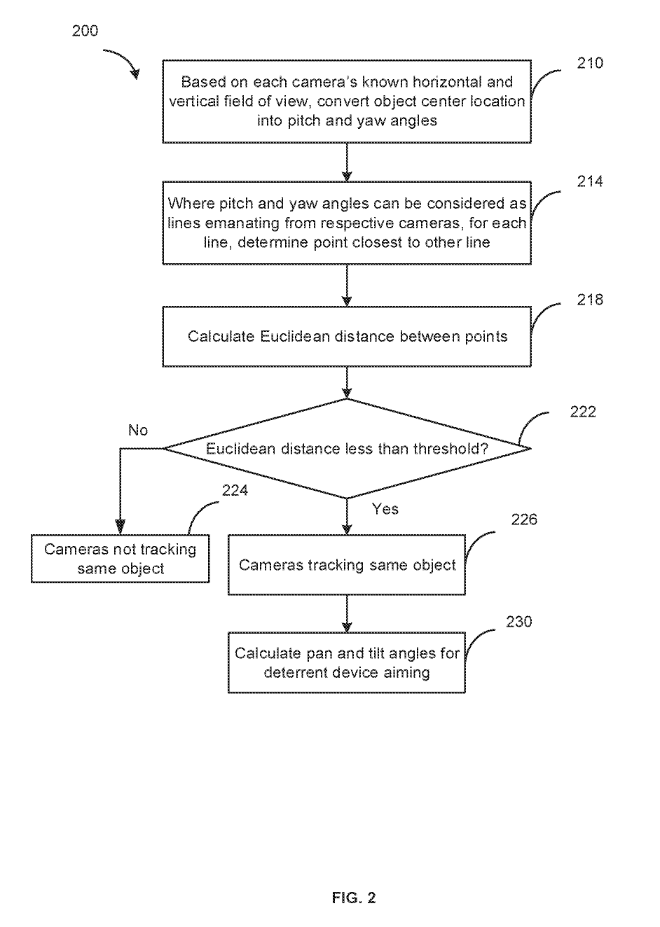

The location, direction and field of view of each of the at least two cameras should be known, and therefore data from the at least two cameras can be employed to determine pan and tilt angles for deterrent device aiming by the positioning module 56. Specifics of this determining method 200 are now detailed with reference to FIG. 2. Also, it will be understood that the cameras employed in connection with the method 200 may be digital cameras; however, alternatively the cameras may also be conventional analog security cameras (or even non-conventional HD analog cameras).

FIG. 2 is a flow chart illustrating the method 200 in accordance with an example embodiment. As a first action in the illustrated method 200, the positioning module 56 converts (210) a center location of an object (i.e. the object of interest within the field of view of the camera) into pitch and yaw angles (relative to the respective camera). This is done for each of the at least two cameras, based on each camera's known horizontal and vertical field of view. Next, treating the calculated pitch and yaw angles for each camera as a line in 3D space emanating from that camera, the positioning module 56 determines (214) a point on each line where it is closest to the other line. (For perfect measurements, the lines will intersect at a single point, meaning no distance between points; however in reality instead of the ideal intersecting lines scenario there is distance between points, because measurements are not perfect.) It will be appreciated that object position determination, as presently described in connection with the method 200, may be considered to be a type of triangulation, since the position is being determined through a calculation based on angles.

Next, the positioning module 56 calculates (218) the Euclidean distance between the points on each line. Once this distance is calculated, the positioning module 56 checks (222) whether the Euclidean distance is less than or greater than a suitable threshold (one skilled in the art will appreciate that the suitable threshold can be determined in a straightforward manner, and that the threshold does not necessarily need to be a fixed threshold, but may instead be, for instance, a dynamically varying threshold based on detected object size as calculated by the video analytics module 24). If the distance is greater than the threshold, then the positioning module 56 determines (224) that the cameras are not tracking the same object. If the distance is less than the threshold, then the positioning module 56 determines (226) that the cameras are successfully tracking the same object. Once it is determined that the cameras are successfully tracking the same object, the positioning module 56 calculates pan and tilt angles for deterrent device aiming. This can be calculated because certain positions—i) the predetermined camera positions; and ii) the determined object position,—are known and can be used to provide or derive values to make the calculations.

It will be noted that the method 200 is applicable even when there is more than one object detected in a scene. For such a case the calculating (218) of the Euclidean distance between the points on each line is further employed to match same objects as between the at least two cameras. By comparing every object from one camera against every other object from the other, matches are established based on lowest Euclidean distances.

Instead of the converting (210) of the center location of the object into pitch and yaw angles, it is also possible to use, in an alternative version of the method, the full bounding box of the object, if available, as provided in connection with analytics (i.e. the full bounding box is used instead of just the center location). For this alternate method, each corner of the bounding box is treated as a line in 3D space, such that the resulting object would be a rectangular pyramid emanating from the camera. Then, instead of calculating the closest point (and distance) between two lines, one would detect any overlap between rectangular pyramids of the two cameras.

With reference again to FIG. 1, the video surveillance system 10 further includes a deterrence device 64 operable to emit a physical effect. The physical effect is such that it deters, restricts or prevents movement of an object. For example, the physical effect may be one that causes discomfort to a human, and which further deters, restricts or prevents the human from moving in a particular detection. The physical effect may be projecting of a physical element, such as shooting a projectile, spraying water (for example, water cannon), emitting smoke, shooting an ink cartridge (for example, a paintball), emitting ultrasonic waves, emitting loud noise, or emitting ultra-low frequency sound. Also, as has already been discussed, in some example embodiments the egress port of the deterrence device 64 will be positioned very close to one of the cameras 16; however it will be understood that, for at least some embodiments, there will be no restriction of consequential significance on the position of the deterrence device 64 relative to any of the cameras 16. In some examples, the deterrence device 64 may include a camera that conspicuously points at and follows the object of interest in a manner to maintain the conspicuousness, noting that a person may become discomforted by a camera lens being continuously pointed at them (especially if there is a nefarious purpose for their presence somewhere they are unauthorized to be).

The video surveillance system 10 further includes a deterrence device controller 68. The deterrence device controller 68 is operable to control deployment of the deterrence device 64. The deterrence device controller 68 may be operable to receive the location determined by the positioning module 56 and to control the deterrence device 64 so that it is aimed at the physical location. The deterrence device controller 68 is further operable to control the deterrence device 64 to selectively emit the physical effect. In some example embodiments, the deterrence device 64 is able to aim at and follow an object tracked by the object tracking module. Different types of following movements of the deterrence device 64 are contemplated. For example, the deterrence device 64 can move in a coarse and periodic manner as it follows a tracked object. As another example, the deterrence device 64 can alternatively move in a finer, more continuous manner as it follows a tracked object. During the tracking phase, a speaker forming a part of the video surveillance system 10 can optionally emit an audible warning message. The warning message can be emitted to provide an opportunity for a person to leave the protected area, after which the deterrence device 64 can proceed from the tracking phase to a deployment phase (absent action by the person to leave the protected area).

According to various example embodiments, the positioning module 56 and deterrence device controller 68 are selectively operated in response to metadata generated from the video analytics module 24. More specifically, the set of appearance characteristics detected by the object appearance module 48 is compared to a set of predetermined appearance rules. When the set of appearance of characteristics detected by the object appearance module 48 and the set of predetermined appearance rules are determined to match, a message may be transmitted to the positioning module 56 and/or deterrence device controller 68 to inform these of the match. There may be a match between the set of appearance characteristics and the set of predetermined appearance rules when these substantially correspond. For example, there may be a match if the set of appearance characteristics and the set of predetermined appearance rules have a correlation that is greater than a predetermined threshold.

In accordance with some examples, i) the set of predetermined appearance rules may be inputted by a human user; and/or ii) the predetermined threshold may also be inputted by a human user.

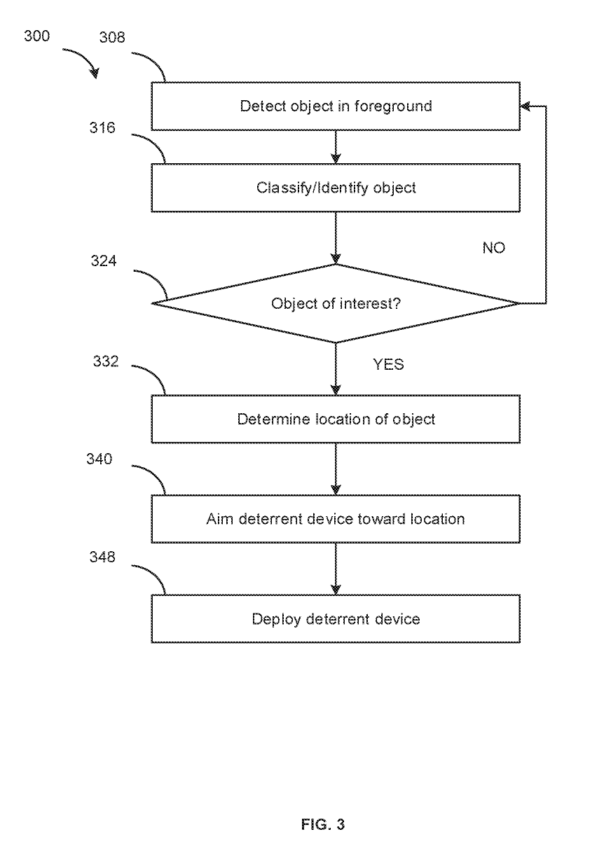

Referring now to FIG. 3, therein illustrated is a flowchart of a method 300 according to one example embodiment for deploying the deterrent device 64 within the video surveillance system 10.

At 308, the video analytics module 24 is operating to detect one or more objects in the foreground of the scene captured by the one or more cameras 16.

At 316, the video analytics module 24 further operates to determine one or more appearance characteristics of the one or more objects detected in the foreground. The video analytics module 24 may also operate to classify the one or more objects detected.

At 324, it is determined whether a detected object is an object of interest. For example, an object may be an object of interest if its appearance characteristics match the set of predetermined appearance rules.

At 332, the location of the object of interest is determined. For example, the positioning module 56 is operated to determine the location of the object of interest in response to receiving a signal from the video analytics module 24 that a match has been detected.

At 340, the deterrent device is controlled to so that it is aimed at the location of the object of interest. For example, the deterrence device controller 68 is operated to control the deterrence device to be aimed at the location of the object of interest.

At 348, after aiming the deterrence device towards the location of the object of interest, the deterrence device is deployed.

Therefore, the above discussed embodiments are considered to be illustrative and not restrictive, and the invention should be construed as limited only by the appended claims.

1. A video surveillance system comprising:
at least one camera module defining a first field of view and being operable for generating image data corresponding to the first field of view;
a video analytics module being configured to detect a foreground visual object falling within the first field of view, classify the visual object, and determine an appearance of the visual object;
a positioning module being configured to determine a physical location of the visual object;
a deterrence device controller communicatively coupled to the positioning module, and the deterrence device controller being configured to receive the physical location of the visual object from the positioning module; and
a deterrence device operable under control of the deterrence device controller to be aimed at the physical location of the visual object, and the deterrence device controller being further configured to control the deterrence device to selectively emit the physical effect.

2. The video surveillance system of claim 1, wherein the deterrence device controller is further configured to control the deterrence device to selectively emit the physical effect in response to the video analytics module determining the appearance of the visual object to match a predetermined appearance of interest.

3. The video surveillance system of claim 1, wherein the positioning module is further configured to determine the physical location of the visual object in response to the video analytics module determining the appearance of the visual object to match a predetermined appearance of interest.

4. The video surveillance system of claim 3, wherein the predetermined appearance of interest is user-defined.

5. The video surveillance system of claim 1, wherein the positioning module is further configured to:
i) receive a plurality of image data generated by a plurality of camera modules, each of the camera modules capturing the visual object; and
ii) calculate the physical location of the visual object from the plurality of image data based on known positions of the plurality of the camera modules and triangulation.

6. The video surveillance system of claim 1, wherein the image data is primary image data and the video analytics module is contained in an external processing appliance or server.

7. A method comprising:
generating image data corresponding to a first field of view of a camera module;
detecting a foreground visual object falling within the first field of view;
after the detecting, classifying the visual object and determining an appearance thereof;
determining a physical location of the visual object;
receiving, at a deterrence device controller, the determined physical location of the visual object; and
aiming a deterrence device at the physical location of the visual object; and
selectively emitting the physical effect from the deterrence device, and
wherein both the aiming and the selectively emitting are controlled by the deterrence device controller.

8. The method of claim 7, wherein the selectively emitting the physical effect is in response to a video analytics module determining the appearance of the visual object matches a predetermined appearance of interest.

9. The method of claim 7, wherein the determining the physical location of the visual object is in response to the video analytics module determining the appearance of the visual object to match a predetermined appearance of interest.

10. The method of claim 9, wherein the predetermined appearance of interest is user-defined.

11. The method of claim 7, further comprising:
receiving a plurality of image data generated by a plurality of camera modules, each of the camera modules capturing the visual object; and
calculating the physical location of the visual object from the plurality of image data based on known positions of the plurality of the camera modules and triangulation.

12. The method of claim 7, wherein the image data is primary image data.
